(19) United States
(12) Patent Application Publication
(10) Pub. No.: US 2008/0138594 A1
(43) Pub. Date: Jun. 12, 2008

(54) CRACK-FREE COATINGS AND RELATED COATED SUBSTRATES AND METHODS

(76) Inventors: Shan Cheng, Pittsburgh, PA (US); Irina G. Schwendeman, Wexford, PA (US); Richard J. Foukes, Mars, PA (US); Kevin P. Gallagher, Gibsonia, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/567,957

(22) Filed: Dec. 7, 2006

(51) Int. Cl. B05D 1/36

(52) U.S. Cl. 428/220; 427/407.1

(57) ABSTRACT

Methods for providing a crack-free hard coat are disclosed. The methods include (i) depositing a primer layer having a coefficient of thermal expansion of 300 to 600 μm/min·° C. measured at a temperature range below the glass transition temperature of the primer layer, wherein the primer layer has a film thickness of at least 1 micron and is formed from a thermoplastic acrylic composition, and (ii) depositing the hard coat over at least a portion of the primer layer, wherein the hard coat has a thickness of at least 2 μm and is formed from a composition comprising an alkoxide.

### FIELD OF THE INVENTION

The present invention relates to crack-free coatings, substrates at least partially coated with such coatings, and methods for providing a crack-free hard coat on a substrate.

### BACKGROUND INFORMATION

Plastic substrates, including, but not limited to, transparent plastic substrates, are desired for a number of applications, such as automotive parts and accessories, including, but not limited to, mirror shells, pillars, such as A pillars, B pillars, and C pillars, sunroofs, vent grills, exterior trim and windshields; lenses; and consumer electronics equipment, among other things. To minimize scratching, as well as other forms of degradation, sol-gel based “hard coats”, which are often clear, are commonly applied as protective layers to such substrates. A primer is often used to enhance adhesion between such a sol-gel hard coat and the substrate. In many cases, it is desirable to utilize a thermoplastic acrylic primer as opposed to a primer that utilizes a thermosetting polymer, because, for example, a thermoplastic polymer does not require a thermal cure as is often the case with thermosetting polymer, thereby simplifying the application process, saving energy, and, in many cases, providing more consistent results.

In certain applications, such as certain automotive parts applications, the coated substrate may need to satisfy stringent abrasion resistance requirements and may need to be extremely resistant to ultraviolet light degradation. As a result, it may be desirable, or necessary, to provide relatively thick primer and/or hard coat layers to meet such requirements. Unfortunately, because sol-gel hard coats cure as a result of condensation of multi-functional silanol oligomers to form highly crosslinked three dimensional networks, they are particularly susceptible to cracking, particularly when applied at higher film thicknesses.

As a result, it would be desirable to provide a hard coat containing coating system that includes a thermoplastic acrylic primer, wherein the hard coat is resistant to cracking even when applied at higher film thicknesses and wherein, in at least some cases, the coating system is resistant to ultraviolet light degradation and/or abrasion. It would also be desirable to provide a method for providing a crack-free hard coat on a substrate utilizing a primer layer formed from a thermoplastic acrylic composition.

### SUMMARY OF THE INVENTION

In certain respects, the present invention is directed to methods for providing a crack-free hard coat on a substrate. These methods comprise (a) depositing a primer layer having a coefficient of thermal expansion of 300 to 600 micron (“μm”)/min·° C. measured at a temperature range below the glass transition temperature of the primer layer, wherein the primer layer has a film thickness of at least 1 μm and is formed from a thermoplastic acrylic composition; and (b) depositing the hard coat over at least a portion of the primer layer, wherein the hard coat has a thickness of at least 2 μm and is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero.

In other respects, the present invention is directed to a coating system. These coating systems comprise (a) a primer layer having a coefficient of thermal expansion of 300 to 600 μm/min·° C. measured at a temperature range below the glass transition temperature of the primer layer, wherein the primer layer has a film thickness of at least 1 μm and is formed from a thermoplastic acrylic composition; and (b) a hard coat deposited over at least a portion of the primer layer, wherein the hard coat has a thickness of at least 2 μm and is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero.

The present invention is also related to substrates at least partially coated with such coating systems and by such methods.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously mentioned, certain embodiments of the present invention are directed to methods for providing a crack-free hard coat on a substrate. As used herein, the term “crack-free” means that there are no cracks in the coating that are visible to the naked eye when viewed at any distance. As used herein, the term “hard coat” refers to a coating that offers one or more of chip resistance, impact resistance, abrasion resistance, UV light degradation resistance, humidity resistance and/or chemical resistance.

Any substrate can be coated in accordance with the methods of the present invention, including, but not limited to, cellulosic-containing substrates, metallic substrates, silicatic substrates, textile substrates, leather substrates, and compressible substrates, including foam substrates. In certain embodiments, however, the substrate is a polymeric substrate. Examples of suitable polymeric substrates include, but are not limited to, substrates constructed of polystyrene, polyamide, polyester, polyethylene, polypropylene, a melamine resin, polyacrylate, polyacrylonitrile, polyurethane, polycarbonate, polyvinyl chloride, polyvinyl alcohols, polyvinyl acetate, polyvinylpyrrolidone and/or a corresponding copolymer and/or block copolymer, biodegradable polymers and natural polymers—such as gelatin. Also suitable are acrylonitrile butadiene styrene, blends of polyphenylene ether and polystyrene, polyetherimide, polyester, polysulfone, acrylic, and copolymers and/or blends thereof. In certain embodiments, the substrate is a polycarbonate, such as that which is described in U.S. Pat. No. 4,239,798 at col. 2, line 25 to col. 3, line 3, the cited portion of which being incorporated herein by reference.

As indicated, the methods of the present invention comprise depositing a primer layer to the substrate. In certain embodiments, prior to such deposition, the substrate surface may be treated by cleaning. Effective treatment techniques for plastics include ultrasonic cleaning; washing with an aqueous mixture of organic solvent, e.g., a 50:50 mixture of isopropanol:water or ethanol:water; UV treatment; activated gas treatment, e.g., treatment with low temperature plasma or corona discharge, and chemical treatment such as hydroxylation, i.e., etching of the surface with an aqueous solution of alkali, e.g., sodium hydroxide or potassium hydroxide, that may also contain a fluorosurfactant. See U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials.

In the methods of the present invention, the primer layer is deposited from a thermoplastic acrylic composition. As used herein, the term “thermoplastic acrylic composition” refers to a composition comprising an acrylic polymer, wherein the acrylic polymer consists essentially of a thermoplastic acrylic polymer. As used herein, the term “thermoplastic acrylic polymer” refers to non-reactive polymers that result from the polymerization of one or more acrylic acid ester monomers and/or methacrylic acid ester monomers, such as those represented by the general formula CH₂═CYCOOR¹, wherein Y is H or a methyl radical and R¹ is an alkyl radical containing, for example, 1 to 20 carbon atoms.

Examples of alkyl groups represented by R¹ in the above general formula include, but are not limited to, methyl, ethyl, n-propyl, isopropyl, sec-butyl, tert-butyl, isobutyl, n-amyl, and the various positional isomers thereof, and likewise the corresponding straight and branched chain isomers of hexyl, heptyl, octyl, nonyl, decyl, and the like.

Exemplary acrylic acid ester monomers represented by the above general formula include, but are not limited to, methyl acrylate, isopropyl acrylate, n-propyl acrylate, n-butyl acrylate, isobutyl acrylate, sec-butyl acrylate, 2-ethylhexyl acrylate, etc. Exemplary methacrylic acid ester monomers represented by the above general formula include, but are not limited to, methyl methacrylate, ethyl methacrylate, n-butyl methacrylate, isobutyl methacrylate, hexyl methacrylate, etc. Copolymers of the above acrylate and/or methacrylate monomers are also included within the term “thermoplastic acrylic polymers” as used herein. The polymerization of the monomeric acrylic acid esters and methacrylic acid esters to provide the thermoplastic acrylic polymers useful in the practice of the invention may be accomplished by any of the well known polymerization techniques.

The thermoplastic acrylic polymers useful in the present invention include acrylic ester homopolymers derived from acrylic acid ester monomers; methacrylic ester homopolymers derived from methacrylic acid ester monomers; and copolymers derived from two different acrylic acid ester monomers, or two different methacrylic acid ester monomers, or an acrylic acid ester monomer and a methacrylic acid ester monomer.

Mixtures of two or more of the aforedescribed thermoplastic acrylic polymers, e.g., two or more different acrylic ester homopolymers, two or more different acrylic ester copolymers, two or more different methacrylic ester homopolymers, two or more different methacrylic ester copolymers, an acrylic ester homopolymer and a methacrylic ester homopolymer, an acrylic ester copolymer and an acrylic ester copolymer, an acrylic ester homopolymer and a methacrylic ester copolymer, etc., can also be used in the present invention.

The thermoplastic acrylic polymers utilized in the present invention differ from thermosetting acrylic polymers in that the thermoplastic acrylic polymers are formed and applied under conditions such that the functional groups, if any, present on the polymer do not react between themselves or with another material to effect a cross-linkage between polymers. As a result, the polymeric components in the thermoplastic acrylic composition are not joined by covalent bonds and thereby can undergo liquid flow upon heating and are soluble in solvents.

In certain embodiments, the thermoplastic acrylic polymer described herein has a weight average molecular weight of at least 20,000, in some cases at least 40,000, in yet other cases, at least 60,000, and, in yet other cases at least 200,000 or at least 400,000 as determined by gel permeation chromatography using a polystyrene standard.

In addition to the thermoplastic acrylic polymer, the thermoplastic acrylic composition often comprises other components. For example, in certain embodiments, the thermoplastic acrylic polymer is dissolved in a volatile solvent, often an organic solvent. In certain embodiments, the concentration of the thermoplastic acrylic polymer in the thermoplastic acrylic composition ranges from 0.5 to 25 percent by weight, in some cases 1 to 15 percent by weight, with the weight percents being based on the total weight of the composition. In certain embodiments, the amount of solvent present ranges from 20 to 95 weight percent, such as 50 to 95 weight percent, based on the total weight of the composition.

Examples of suitable organic solvents for use in such compositions include, but are not limited to: benzene, toluene, methyl ethyl ketone, methyl isobutyl ketone, acetone, ethanol, diacetone alcohol, tetrahydrofurfuryl alcohol, propyl alcohol, propylene carbonate, N-methylpyrrolidinone, N-vinylpyrrolidinone, N-acetylpyrrolidinone, N-hydroxymethylpyrrolidinone, N-butyl-pyrrolidinone, N-ethylpyrrolidinone, N—(N-octyl)-pyrrolidinone, N-(n-dodecyl)pyrrolidinone, 2-methoxyethyl ether, xylene, cyclohexane, 3-methylcyclohexanone, ethyl acetate, butyl acetate, tetrahydrofuran, methanol, amyl propionate, methyl propionate, diethylene glycol monobutyl ether, dimethyl sulfoxide, dimethyl formamide, ethylene glycol, mono- and dialkyl ethers of ethylene glycol and their derivatives, which are sold as CELLOSOLVE industrial solvents by Union Carbide, propylene glycol methyl ether and propylene glycol methyl ether acetate, which are sold as DOWANOL® PM and PMA solvents, respectively, by Dow Chemical and mixtures thereof.

As previously indicated, in certain embodiments of the methods of the present invention, the primer layer that is formed from the thermoplastic acrylic composition has a coefficient of thermal expansion (“CTE”) of 300 to 600 μm/min·° C. measured within a temperature range below the glass transition temperature of the primer layer, such as 20 to 60° C., in accordance with test description described in the Examples herein. Indeed, it has been surprisingly discovered that a crack-free coating system can be achieved at the primer layer and hard coat layer film thicknesses of the present invention when the primer layer has such a CTE. By contrast, when the CTE of the primer layer is substantially outside of the previously recited range, it has been observed that cracking occurs in the hard coat when the primer layer and hard coat layer have the film thicknesses utilized in the present invention.

It has been discovered that such a primer layer can be formed through the inclusion of significant quantities of a plasticizer in the thermoplastic acrylic composition. In particular, it has been discovered that the type and quantity of plasticizer included in the thermoplastic acrylic composition can be selected so as to result in both: (i) the deposition of a primer layer having both the desired CTE, which is believed to permit the formation of a crack-free hardcoat at the film thicknesses used in the present invention, and (ii) the deposition of a primer layer having a sufficient glass transition temperature so that the abrasion resistance capabilities of the hard coat are not unacceptably affected.

In certain embodiments, therefore, the thermoplastic acrylic compositions described herein also comprise a plasticizer. As used herein, the term “plasticizer” refers to a material that acts to reduce the Tg or increase the flexibility of a coating formed from a composition. In certain embodiments of the present invention, the plasticizer comprises a non-UV absorbing material, such as an aromatic ring-containing inert plasticizer, examples of which include, but are not limited to, dioctyl phthalate, alkylene oxide dibenzoate, alkoxylated phenol benzoate, alkoxylated naphthol benzoate, bis(phenylthio)propane-1,3, bis(phenylthio)alkylene ether, the reaction product of phenyl chloroformate and dimercaptan, the reaction product of dimercaptan and phosgene endcapped with phenol, cinnamates, triphenyl phosphite, tri(2-ethylhexyl)trimellitate; triisodecyl trimellitate; poly(alkylene glycol)dinaphthoate, 2-ethylhexyl diphenyl phosphate, isodecyl diphenyl phosphate, tricresyl phosphate, or any combination thereof.

In certain embodiments, the plasticizer comprises an ultraviolet light absorbing material and, therefore, their use provides additional ultraviolet light degradation protection to the coating system while also supporting the goal of achieving a crack-free coating system at the coating film thicknesses of the present invention. As a result, in these embodiments of the present invention, the plasticizer may comprise, for example, a benzotriazole, a triazine, an oxanilide, a benzophenone and the like, including mixtures thereof.

In certain embodiments, the ultraviolet light absorber is a substituted benzophenone, such as 2-hydroxybenzophenone, 2,4-dihydroxybenzophenone, 2-(2H-benzotriazol-2-yl)phenol, or 2,2′,4,4′-tetrahydroxybenzophenone. In certain embodiments, the ultraviolet light absorber is not a dibenzoylresorcinal ultraviolet light absorber, such as is described in U.S. Pat. No. 6,037,059.

In certain embodiments, the thermoplastic acrylic composition comprises a plasticizer that is a mixture of a non-UV absorbing material and a UV absorbing material.

As previously indicated, in certain embodiments of the primer compositions utilized in the present invention, the plasticizer is utilized in significant quantities so as to form a primer composition that deposits a primer layer having a CTE within the range specified above. In certain embodiments, the weight ratio of resin solids to plasticizer in the primer compositions utilized in the present invention is no more than 5.5:1, in some cases no more than 4:1, and, in yet other cases, no more than 2:1.

Moreover, in certain embodiments, the plasticizer(s) are utilized in quantities so as to form a primer composition that deposits a primer layer having a glass transition temperature (Tg) of at least 70° C., in some cases from 70 to 100° C., and, in yet other cases, from 70 to 90° C. The primer layer Tg values reported herein, including the Examples, are determined in a manner well understood by those skilled in the art by dynamic mechanical thermal analysis (DMTA) using a TA Instruments DMA 2980 DMTA analyzer conducted under nitrogen.

The primer composition can be prepared by any suitable method and the Examples herein illustrate one such method. The primer composition may be applied to the substrate using, for example, any conventional coating technique including flow coating, dip coating, spin coating, roll coating, curtain coating and spray coating. Application of the coating composition to the substrate may, if desired, be done in an environment that has a relative humidity of no more than 50% and is substantially free of dust or contaminants, e.g., a clean room. In the methods and systems of the present invention, the primer composition is applied so as to result in a primer layer having a film thickness of at least 1 μm, such as 1 to 10 μm, and, in some cases, from 3 to 6 μm. The film thickness values reported herein, including the examples, are measured with a spectrometer operated with OOIBase 32 operating software, commercially available from Ocean Optics Inc.

Following application of the primer composition, the composition is often dried by removing the carrier solvent from the composition. Such drying can be accomplished via air drying, oven drying, or a combination thereof. In certain embodiments, for example, the primer composition is dried by exposing the composition to ambient conditions for a brief period of time, such as less than 10 minutes, such as 5 minutes, followed by heating the primer composition to a temperature of 90° to 130° C., such as 120° C., for less than 20 minutes, such as 10 minutes.

As indicated, in the methods of the present invention, a hard coat is deposited over at least a portion of the primer layer. In the present invention, such a hard coat is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero. Examples of suitable organic radicals include, but are not limited to, alkyl, vinyl, methoxyalkyl, phenyl, γ-glycidoxy propyl and γ-methacryloxy propyl. The alkoxide can be further mixed and/or reacted with other compounds and/or polymers known in the art. Particularly suitable are compositions comprising siloxanes formed from at least partially hydrolyzing an organoalkoxysilane, such as one within the formula above. Examples of suitable alkoxide-containing compounds and methods for making them are described in U.S. Pat. Nos. 6,355,189; 6,264,859; 6,469,119; 6,180,248; 5,916,686; 5,401,579; 4,799,963; 5,344,712; 4,731,264; 4,753,827; 4,754,012; 4,814,017; 5,115,023; 5,035,745; 5,231,156; 5,199,979; and 6,106,605, all of which are incorporated by reference herein.

In certain embodiments, the composition from which the hard coat is formed comprises an alkoxide that is a combination of a glycidoxy[(C₁-C₃)alkyl]tri(C₁-C₄)alkoxysilane monomer and a tetra(C₁-C₆)alkoxysilane monomer. Glycidoxy[(C₁-C₃)alkyl]tri(C₁-C₄)alkoxysilane monomers suitable for use in such compositions include glycidoxymethyltriethoxysilane, α-glycidoxyethyltrimethoxysilane, α-glycidoxyethyltriethoxysilane, β-glycidoxyethyltrimethoxysilane, β-glycidoxyethyltriethoxysilane, α-glycidoxy-propyltrimethoxysilane, α-glycidoxypropyltriethoxysilane, β-glycidoxypropyltrimethoxysilane, β-glycidoxypropyl-triethoxysilane, γ-glycidoxypropyltrimethoxysilane, hydrolysates thereof, or mixtures of such silane monomers.

Suitable tetra(C₁-C₆)alkoxysilanes that may be used in combination with the glycidoxy[(C₁-C₃)alkyl]tri(C₁-C₄)alkoxysilane monomer in certain embodiments of the present invention include, for example, materials such as tetramethoxysilane, tetraethoxysilane, tetrapropoxysilane, tetrabutoxysilane, tetrapentyloxysilane, tetrahexyloxysilane and mixtures thereof.

In certain embodiments, the glycidoxy[(C₁-C₃)alkyl]tri(C₁-C₄)alkoxysilane and tetra(C₁-C₆)alkoxysilane monomers are present in a weight ratio of glycidoxy[(C₁-C₃)alkyl]tri(C₁-C₄)alkoxysilane to tetra(C₁-C₆)alkoxysilane of from 0.5:1 to 100:1, such as 0.75:1 to 50:1 and, in some cases, from 1:1 to 5:1.

In certain embodiments, the alkoxide (or combination of two or more thereof described above) is present in the hard coat composition in an amount of 5 to 75 percent by weight, such as 10 to 70 percent by weight, or, in some cases, 20 to 65 percent by weight, or, in yet other cases, 25 to 60 percent by weight, with the weight percent being based on the total weight of the composition.

In certain embodiments, water is provided in an amount necessary for the hydrolysis of the hydrolyzable alkoxide(s). For example, in certain embodiments, water is present in an amount of at least 1.5 moles of water per mole of hydrolyzable alkoxide. In certain embodiments, atmospheric moisture can be adequate.

In certain embodiments, a catalyst is provided to catalyze the hydrolysis and condensation reaction. In certain embodiments, the catalyst is an acidic material and/or a material, different from the acidic material, which generates an acid upon exposure to actinic radiation. In certain embodiments, the acidic material is chosen from an organic acid, inorganic acid or mixture thereof. Non-limiting examples of such materials include acetic, formic, glutaric, maleic, nitric, hydrochloric, phosphoric, hydrofluoric, sulfuric acid or mixtures thereof.

Any material that generates an acid on exposure to actinic radiation can be used as a hydrolysis and condensation catalyst in the coating compositions of the present invention, such as a Lewis acid and/or a Bronsted acid. Non-limiting examples of acid generating compounds include onium salts and iodosyl salts, aromatic diazonium salts, metallocenium salts, o-nitrobenzaldehyde, the polyoxymethylene polymers described in U.S. Pat. No. 3,991,033, the o-nitrocarbinol esters described in U.S. Pat. No. 3,849,137, the o-nitrophenyl acetals, their polyesters and end-capped derivatives described in U.S. Pat. No. 4,086,210, sulphonate esters or aromatic alcohols containing a carbonyl group in a position alpha or beta to the sulphonate ester group, N-sulphonyloxy derivatives of an aromatic amide or imide, aromatic oxime sulphonates, quinone diazides, and resins containing benzoin groups in the chain, such as those described in U.S. Pat. No. 4,368,253. Examples of these radiation activated acid catalysts are also disclosed in U.S. Pat. No. 5,451,345.

In certain embodiments, the acid generating compound is a cationic photoinitiator, such as an onium salt. Non-limiting examples of such materials include diaryliodonium salts and triarylsulfonium salts, which are commercially available as SarCat® CD-1012 and CD-1011 from Sartomer Company. Other suitable onium salts are described in U.S. Pat. No. 5,639,802, column 8, line 59 to column 10, line 46. Examples of such onium salts include 4,4′-dimethyldiphenyliodonium tetrafluoroborate, phenyl-4-octyloxyphenyl phenyliodonium hexafluoroantimonate, dodecyldiphenyl iodonium hexafluoroantimonate, [4-[(2-tetradecanol)oxy]phenyl]phenyl iodonium hexafluoroantimonate and mixtures thereof.

The amount of catalyst used in the compositions from which the hard coat is formed can vary widely and depend on the particular materials used. In certain embodiments, the acidic material and/or acid generating material can be used in an amount from 0.01 to 5 percent by weight, based on the total weight of the composition.

In certain embodiments, the composition from which the hard coat is formed includes other additive materials, such as tints or colorants and/or photochromic compounds, including those described in United States patent application Publication 2002/00651407 at [0051] to [0056], the cited portion of which being incorporated herein by reference.

The composition from which the hard coat is formed can also include one or more standard additives, such as flow additives, rheology modifiers, adhesion promoters, and the like. In certain embodiments, such compositions comprise an ultraviolet light absorber, such as, for example, any of those described earlier with respect to the primer composition. In certain embodiments, the ultraviolet light absorber is present in the composition from which the hard coat is formed in an amount of 5 to 15 percent by weight, based on the total solids weight of the composition.

The composition from which the hard coat is formed can be prepared by any suitable method and the Examples herein illustrate one such method. The composition from which the hard coat is formed may be applied to the substrate using, for example, any conventional coating technique including flow coating, dip coating, spin coating, roll coating, curtain coating and spray coating. In the methods and systems of the present invention, the composition from which the hard coat is formed is applied so as to result in a hard coat having a film thickness of at least 2 μm, such as 3 to 10 μm, and, in some cases, from 4 to 8 μm.

Following application of the hard coat composition to the substrate, the composition is cured, such as by flashing the coating at ambient temperature for up to one hour, and then baking the coating at an appropriate temperature and time, which can be determined by one skilled in the art based upon the particular coating and/or substrate being used. As used herein, the terms “cured” and “curing” refer to the at least partial crosslinking of the components of the coating that are intended to be cured, i.e., cross-linked. In certain embodiments, the crosslink density, i.e., the degree of crosslinking, ranges from 35 to 100 percent of complete crosslinking. The presence and degree of crosslinking, i.e., the crosslink density, can be determined by a variety of methods, such as dynamic mechanical thermal analysis (DMTA) using a Polymer Laboratories MK III DMTA analyzer, as is described in U.S. Pat. No. 6,803,408, at col. 7, line 66 to col. 8, line 18, the cited portion of which being incorporated herein by reference.

In certain embodiments, when a material that generates an acid on exposure to actinic radiation is present in the composition from which the hard coat is formed, as described above, such a composition may be at least partially cured by irradiating the coated substrate with a curing amount of ultraviolet light, either after thermally curing the coating, simultaneously during a thermal curing process, or in lieu of a thermal curing process. During the irradiation step, the coated substrate may be maintained at room temperature, e.g., 22° C., or it may be heated to an elevated temperature which is below the temperature at which damage to the substrate occurs.

In certain embodiments, the methods of the present invention result in a coating system that is crack-free, abrasion resistant, ultraviolet light degradation resistant, and/or adherent to the substrate. As used herein, the term “abrasion-resistant” refers to a coating having a haze of no more than 15% when measured in accordance with a standard Taber Abrasion Test (ANSI/SAE 26.1-1996), with haze being measured after 300 taber abrasion cycles. As used herein, the phrase “UV light degradation resistant” refers to coatings that exhibit a delta yellow index after 5000 hours weatherometer exposure in accordance with SAE J1960, of no more than 2.0. “Adherent to the substrate”, for purposes of the present invention, means that the coating adheres to the substrate when tested using a Crosshatch adhesion test, wherein a multi-blade cutter (Paul N. Gardner Company, Inc.) is used. In particular, a coated panel is scribed twice (at 90°), making sure the blades cut into the substrate. Coating adhesion is measured using Nichiban LP-24 tape or 3M #610 tape (one pull adjacent to the substrate). Adhesion is rated on a 0-5 scale (5=100% adhesion, 0=0% adhesion). For purposes of the present invention, the coating is “adherent to the substrate” if the adhesion rating is a 5.

As will be apparent from the foregoing description, the present invention is also directed to an article at least partially coated with a coating system comprising: (a) a primer layer having a coefficient of thermal expansion of 300 to 600 μm/min·° C. measured at a temperature range below the glass transition temperature of the primer layer, wherein the primer layer has a film thickness of at least 1 μm is formed from a thermoplastic acrylic composition; and (b) a hard coat deposited over at least a portion of the primer layer, wherein the hard coat has a thickness of at least 2 μm and is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero. In certain embodiments, such an article is an automotive part selected from a pillar, such as an A pillar, a B pillar or a C pillar, and a sunroof.

The present invention is also directed to a coating system comprising: (a) a primer layer having a coefficient of thermal expansion of 300 to 600 μm/min·° C. measured at a temperature range below the glass transition temperature of the primer layer, wherein the primer layer has a film thickness of at least 1 μm is formed from a thermoplastic acrylic composition; and (b) a hard coat deposited over at least a portion of the primer layer, wherein the hard coat has a thickness of at least 2 μm and is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero.

In addition, the present invention is directed to a coating system comprising: (a) a primer layer having a film thickness of at least 1 μm that is formed from a thermoplastic acrylic composition comprising a thermoplastic acrylic polymer and a plasticizer wherein the weight ratio of resin solids to plasticizer in the composition is no more than 5.5:1; and (b) a hard coat deposited over at least a portion of the primer layer, wherein the hard coat has a thickness of at least 2 μm and is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero.

Illustrating the invention are the following examples that are not to be considered as limiting the invention to their details. All parts and percentages in the examples, as well as throughout the specification, are by weight unless otherwise indicated.

### EXAMPLE 1

### Primer Composition Preparation

To prepare primers #1 through #6 in Table 1, primer solutions 1 or 2 were pre-prepared as component A, then a proper amount of component B (see Table 1) was added into component A under stirring. The solution was kept stirred until component B was completely dissolved. Detailed procedures to prepare primer solution 1 are as follows: 1092.0 grams of Dowanol PM and 364.0 grams of diacetone alcohol were charged into a flask under nitrogen. The solvent mixture was stirred and heated to 80° C. Then, 80.0 grams of Elvacite® 2041, a high molecular weight acrylic resin commercially available from Lucite International, Inc., was added into the flask. The mixture was kept stirred until Elvacite® resin was completely dissolved. The solution was cooled to room temperature. In a separate beaker, 14.5 grams of Tinuvin® 900, a UV absorber commercially available from Ciba Specialty Chemicals, was pre-dissolved in 80.0 grams of toluene. This Tinuvin 900 solution was then added into the flask containing Elvacite solution under stirring. The mixture was stirred until a clear and homogeneous solution was obtained. With similar procedures, primer solution 2 was prepared except that the Tinuvin® 900 solution was not added.

### EXAMPLE 2

### Hardcoat Composition Preparation

A hardcoat composition was prepared by first mixing 66.00 grams of deionized water and 30.00 grams of methanol in a clean reaction vessel. Increased temperature was observed as the result of the exothermal mixing process. The contents were then cooled with a water bath to 20-25° C. In a separate container, 96.00 grams of methyltrimethoxysilane, 9.60 grams of glycidoxypropyltrimethoxysilane, 4.80 grams of glacial acetic acid, 1.88 grams of Uvinul® 400, commercially available from BASF Corporation, and 4.17 grams of 2-hydroxy-4-(3-triethoxysilylpropoxy)diphenylketone were blended together. This mixture was rapidly added to the reaction vessel under stirring. The water bath kept the maximum reaction temperature at 35-50° C. The maximum temperature was reached 1-2 minutes after the addition. After a half hour, the water bath was removed, and the reaction vessel remained stirred for 16-22 hours. Then, 30.00 grams of 2-propanol, 15.00 grams of diacetone alcohol, 0.24 grams of BYK®-300, a silicone surface additive commercially available from BYK-Chemie USA Inc., and 0.12 grams of sodium acetate tri-hydrate were pre-mixed in a separate container as the third charge. This mixture solution was added into the reaction vessel. The reaction mixture was stirred for additional 4-5 hours. As the final step, 0.48 grams of 25% tetramethylammonium hydroxide solution in methanol and 36.00 grams of ethyl acetate were mixed in a beaker. This solution was then added into the reaction vessel. The reaction mixture was kept stirred for additional 24 hours at room temperature. The coating solution was then filtered and stored refrigerated.

### EXAMPLE 3

### Test Substrates

To prepare test substrates, Mokrolon® transparent polycarbonate plaques, commercially available from Bayer AG, were wiped with 2-propanol. The primer was spin-applied and then flashed at ambient for 5 minutes. Primer coated substrates were baked at 120° C. for 10 minutes and then cooled to room temperature. Over primed substrate, a hardcoat composition was spin-applied, followed with 10 minutes ambient flash and 1 hour baking at 120° C. The coated samples were cool to room temperature. After at least 24 hours, the samples were evaluated for cracking, adhesion and taber abrasion resistance. Hardcoat dry film thickness for all samples was controlled at 4-5 μm.

Representative primer compositions, physical properties, and corresponding coated sample performance are shown below in Table 1 and Table 2. As the testing results showed, hardcoat cracking resistance was improved when applied over primers with certain coefficient of thermal expansion.

TABLE 1

| | Primer example | | | | | | |
|---|---|---|---|---|---|---|---|
| | Control | #1 | #2 | #3 | #4 | #5 | #6 |
| Component A | | | | | | | |
| (parts by weight) | | | | | | | |
| Primer solution 1 | 100.00 | 100.00 | 100.00 | — | 100.00 | 100.00 | — |
| Primer solution 2 | — | — | — | 100.00 | — | — | 100.00 |
| Component B | | | | | | | |
| (parts by weight) | | | | | | | |
| Dioctyl | — | 0.68 | 1.51 | 2.00 | — | — | — |
| isophthalate | | | | | | | |
| Uvinul ® 400 | — | — | — | — | 0.73 | 1.51 | 2.20 |

TABLE 2

| | TEST SUBSTRATE | | | | | | |
|---|---|---|---|---|---|---|---|
| | A | B | C | D | E | F | G |
| | Primer | | | | | | |
| | Control | #1 | #2 | #3 | #4 | #5 | #6 |
| Primer coefficient | 27 ± 1 | 633 ± 70 | 989 ± 7 | 468 ± 20 | 438 ± 144 | 449 ± 89 | 467 ± 32 |
| of thermal | | | | | | | |
| expansion | | | | | | | |
| (μm/min·° C.)¹ | | | | | | | |
| Primer Tg (° C.) | 97.89 | 93.84 | 77.61 | 83.19 | 80.05 | 73.99 | 81.26 |
| Primer thickness | 4–5 | 5–6 | 5–6 | 7–8 | 5–6 | 6–7 | 8–9 |
| (μm) | | | | | | | |
| Adhesion² | 5 | 5 | 5 | 5 | 5 | 5 | 5 |
| Hardcoat cracking³ | 2 | 0.5–1 | 0.5 | 0 | 0 | 0 | 0 |
| Haze % after | 18.6 | 19.1 | 16.2 | 15.3 | 17.8 | 17.4 | 19.6 |
| 300 taber cycles⁴ | | | | | | | |

¹The coefficient of thermal expansion (CTE) was measured with a Dynamical Mechanical Analyzer DMA 2980 from TA Instruments and is reported as the average result of at least two samples with a margin of error included. The instrument was set in controlled force mode where the force applied was 0.005 N. The free standing film was peeled off the substrate, cut in rectangular strips (6 mm by 25 mm) and mounted intension clamps. The temperature was scanned from 20° C. to 60° C. at a heating rate of 3° C./min. The coefficient of thermal expansion for the material is the slope of the dimension change vs temperature curve at temperatures below the Tg of the film.
²Adhesion: Crosshatch, Nichibon LP-24 adhesive tape. Rating scale is 0–5 (no adhesion - 100% adhesion after tape peeling).
³Hardcoat cracking rating scale: 0–3 (0 - no cracking, 1 - a few small cracking, 2 - a few long cracking, 3 - many long cracking). Sample size was 4″ × 4″.
⁴Taber Abrasion: Taber 5150 Abrader, CS-10 abrasive wheels, 500 grams of weight. Haze % was measured after 300 taber abrasion cycles. The abrasive wheels are usually conditioned in desiccator for 24 hours before testing. The wheels used in this test were not conditioned resulting higher haze % after 300 taber abrasion cycles than would be expected (i.e. <7% after 300 taber cycles).

### EXAMPLE 4

Primer #7 in Table 3 was prepared with the following procedures: In a beaker, 9.25 grams of Tinuvin® 900 was pre-dissolved in 40.00 grams of toluene. The Tinuvin® 900 solution, 40.00 grams of Elvacite® 2041, 500.00 grams of Dowanol PM and 187.50 grams of diacetone alcohol were charged into a flask. The mixture was stirred and heated to 85° C. with reflux. The mixture was kept stirred for 1 hour and cooled to room temperature. In a separate beaker, 12.35 grams of Uvinul® 3000, a 2,4-dihroxybenzophenone UV absorber commercially available from BASF Corporation, 0.30 grams of BYK®-306, a silicone surface additive commercially available from BYK-Chemie USA Inc., and 32.50 grams of Dowanol PM was mixed and stirred until a clear and homogeneous solution was obtained. The Uvinul® 3000 containing solution was added into the flask under stirring. The mixture was kept stirred for 30 minutes. The resulting solution was clear and homogeneous.

A test substrate was prepared and tested with the same procedures described in Example 3. The representative sample performance is shown below in Table 3.

TABLE 3

| | |
|---|---|
| Primer coefficient of thermal expansion | 355 ± 20 |
| (μm/min·° C.) | |
| Primer thickness (μm) | 3–5 |
| Adhesion | 5 |
| Hardcoat cracking¹ | 0 |
| Haze % after 300 taber cycles² | <7.5% |
| Delta yellow index after 5000 hours | <0.7 |
| weatherometer exposure³ | |

¹The hardcoat composition was the same as described above in Example 2.
²The abrasive wheels were conditioned in desiccator for 24 hours before testing.
³Test substrate was exposed to accelerated weathering in a Xenon Arc Apparatus, commercially available from Atlas Electric Inc., that was operated in accordance with SAE J1960.

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A method for providing a crack-free hard coat on a substrate, comprising:
(a) depositing a primer layer having a coefficient of thermal expansion of 300 to 600 μm/min·° C. measured at a temperature range below the glass transition temperature of the primer layer, wherein
(i) the primer layer has a film thickness of at least 1 μm and
(ii) the primer layer is formed from a thermoplastic acrylic composition; and
(b) depositing the hard coat over at least a portion of the primer layer, wherein
(i) the hard coat has a thickness of at least 2 μm and
(ii) the hard coat is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero.

2. The method of claim 1, wherein the thermoplastic acrylic polymer has a weight average molecular weight of at least 200,000.

3. The method of claim 1, wherein the thermoplastic acrylic composition comprises a plasticizer.

4. The method of claim 1, wherein the plasticizer comprises an ultraviolet light absorber selected from a benzotriazole, a triazine, an oxanilide, a benzophenone, and a mixture thereof.

5. The method of claim 3, wherein the weight ratio of resin solids to plasticizer in the thermoplastic acrylic composition is no more than 5.5:1.

6. The method of claim 1, wherein the primer layer has a glass transition temperature of at least 70° C.

7. The method of claim 1, wherein the primer layer has a film thickness of 3 to 6 μm.

8. The method of claim 1, further comprising heating the primer layer to a temperature of 90° to 130° C. for less than 20 minutes prior to depositing the hard coat.

9. The method of claim 1, wherein the alkoxide comprises a combination of a glycidoxy[(C₁-C₃)alkyl]tri(C₁-C₄)alkoxysilane monomer and a tetra(C₁-C₆)alkoxysilane monomer.

10. The method of claim 1, wherein the hard coat has a thickness of 4 to 8 μm.

11. A substrate at least partially coated by the method of claim 1.

12. The substrate of claim 11, wherein the substrate is constructed of polycarbonate.

13. A coating system comprising:
(a) a primer layer having a coefficient of thermal expansion of 300 to 600 μm/min·° C. measured at a temperature range below the glass transition temperature of the primer layer, wherein the primer layer has a film thickness of at least 1 μm and is formed from a thermoplastic acrylic composition; and
(b) a hard coat deposited over at least a portion of the primer layer, wherein the hard coat has a thickness of at least 3 μm and is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero.

14. The system of claim 13, wherein the thermoplastic acrylic polymer has a weight average molecular weight of at least 200,000.

15. The system of claim 13, wherein the thermoplastic acrylic composition comprises an ultraviolet light absorber selected from a benzotriazole, a triazine, an oxanilide, a benzophenone, and a mixture thereof.

16. The system of claim 13, wherein the primer layer has a glass transition temperature of at least 70° C.

17. The system of claim 13, wherein the primer layer has a film thickness of 3 to 6 μm.

18. The system of claim 13, wherein the alkoxide comprises a combination of a glycidoxy[(C₁-C₃)alkyl]tri(C₁-C₄)alkoxysilane monomer and a tetra(C₁-C₆)alkoxysilane monomer.

19. The system of claim 13, wherein the hard coat has a thickness of 4 to 8 μm.

20. A substrate at least partially coated by the coating system of claim 13, wherein the substrate is constructed of polycarbonate.

21. A coating system comprising:
(a) a primer layer having a film thickness of at least 1 μm that is formed from a thermoplastic acrylic composition comprising
(i) a thermoplastic acrylic polymer, and
(ii) a plasticizer, wherein
the weight ratio of resin solids to plasticizer in the composition is no more than 5.5:1; and
(b) a hard coat deposited over at least a portion of the primer layer, wherein the hard coat has a thickness of at least 2 μm and is formed from a composition comprising an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero.
